(19) United States
(12) Patent Application Publication
(10) Pub. No.: US 2010/0211457 A1
(43) Pub. Date: Aug. 19, 2010

(54) METHOD AND APPARATUS FOR TRACKING INTERACTIVE EVENTS RELATED TO ADVERTISING

(76) Inventors: Gaelle Christine Martin-Cocher, Mississauga (CA); Michael Shenfield, Mississauga (CA); Dejan Petronijevic, Mississauga (CA)

Correspondence Address: Research in Motion Corp./Q&B;Attn: Glenda Wolfe, Bldg. 6, Brazos East, Suite 100, 5000 Riverside Drive, Irving, TX, 75039, US

(21) Appl. No.: 12/702,845

(22) Filed: Feb. 9, 2010

Related U.S. Application Data
(60) Provisional application No. 61/151,054, filed on Feb. 9, 2009.

(51) Int. Cl. G06Q 30/00; G06Q 10/00; G06F 15/16; G06F 3/048

(52) U.S. Cl. 705/14.45; 709/204; 715/764

(57) ABSTRACT

A method and apparatus for use in a network in a mobile environment provides tracking of interactive events related to electronic advertisements. An application running on the network provides a listing of interactive capabilities to a tracking application, also running on the network. The tracking application identifies interactive events of interest and assigns event codes to these events. During operation, the application reports these events to the tracking application.

This application claims priority to and incorporates by reference in its entirety U.S. patent application No. 61/151,054 that was filed on Feb. 9, 2009 and is titled “Method and Apparatus for Tracking Interactive Events Related to Advertising”.

### BACKGROUND

The present disclosure relates to a method and apparatus for tracking advertisements in communication networks that employ wireless electronic devices, and particularly for tracking and validating interactive events related to advertisements.

In today's information age, targeted marketing efforts are increasingly tied to electronic communications. To provide customized and targeted advertising, many electronic devices such as cell phones and personal web-enabled devices are programmed to provide user data to an advertising server or system. An electronic device can, for example, store a user profile that defines the user's interests, demographics, etc. A web browser running on an electronic device can also track the advertisements viewed by the user and the user's purchase decisions. When properly equipped with a GPS or other locating device, an electronic device can also track the user's location. All of this information can be used to provide targeted advertisements for the user. This data can also be used to monitor impressions, e.g. the number of times an advertisement is presented to potential customers, and to track user actions, such as activations of a “click to” function to access an advertisement. This acquired data can also be used to bill advertisers based on advertisement usage.

In addition to targeted marketing methods, electronic communications are increasingly being used in “viral advertising”. Viral advertising is a sophisticated form of “word of mouth” advertising which seeks to exploit existing social networks among individuals by prompting the recipient of an advertising message, encounter, or impression to relay a marketing message to other consumers. In viral marketing, a nucleus target market is identified and then radiates outward in ever-larger marketing spirals. The ease with which messages and information can be forwarded to many individuals from just one member, particularly through the internet, makes viral marketing through electronic communications extremely effective. To maximize the effectiveness of a viral marketing campaign, however, it is desirable to track usage, identify recipients who are most likely to relay marketing messages to others, and then to direct encounters toward these recipients.

In the mobile communications domain, however, it can be difficult to track the transmission of advertising content between consumers. In some instances the difficulty in tracking may result from advertising content being configured with or otherwise including an interactive/interaction/interactivity mechanism such as an embedded link that provides “click to” functionality. That is, reporting of metrics relating to advertising content including such a mechanism may be erroneous because the interactive capabilities of a mobile device application may not include all of the interactive capabilities found in advertising content. For example, a “click to email” link provided in advertising content delivered to a mobile device such as a cellular phone that does not have email capabilities cannot be used by the application. Alternatively, a mobile device may include interactive capabilities that are not supported by the content provider. When a mismatch of this type occurs, the ability to transfer the advertising message is hindered, and, in some cases, false tracking data may be acquired.

While a number of tracking metrics are presently available for mobile electronic devices, these metrics do not provide feedback to consistently monitor many types of interactive/interaction/interactivity mechanisms such as forwarding and saving operations that may be performed relative to advertising content and that are available in electronic communication devices. Conventional tracking mechanisms, moreover, cannot verify the interactive capabilities of either content provided by service providers, or personal communications devices. Known tracking metrics, therefore, are insufficient to maximize the productivity of targeted and viral marketing methods. In view of the foregoing, new apparatuses, systems and methods for tracking interactive events relating to advertisements on mobile devices would be an important improvement in the art.

### BRIEF DESCRIPTION OF THE DRAWINGS

FIG. 1 illustrates an example network for use in an advertisement/communication network;

FIG. 2 illustrates an example of message flow activities between a tracking application and an application to determine interactive capabilities and track usage of interactive capabilities;

FIG. 3 illustrates an alternate message flow for the network of FIG. 1 where advertising content is provided by the tracking application;

FIG. 4 illustrates an exemplary electronic device for use in a OMA MobAd environment incorporating a tracking application of the type disclosed;

FIG. 5 illustrates a first embodiment of messaging between an Ad Server and an electronic device for tracking interactive events in a OMA MobAd environment;

FIG. 6 illustrates a second embodiment of messaging between an Ad Server and an electronic device for tracking interactive events in a OMA MobAd environment;

FIG. 7 illustrates an exemplary database storing metric event data.

FIG. 8 illustrates an exemplary series of rules for verifying tracked interactive event data; and

FIG. 9 illustrates a flow chart for verifying tracked interactive event data received by a tracking application.

### DETAILED DESCRIPTION

The various aspects of the subject disclosure are now described with reference to the accompanying drawings. It should be understood, however, that the description and drawings are not intended to limit the claimed subject matter to the particular form disclosed. Rather, the intention is to cover all modifications, equivalents, and alternatives falling within the spirit and scope of the claimed subject matter.

As used herein, the terms “component,” “system” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a computer and the computer can be a component. One or more components may reside within a process and/or thread of execution and a component may be localized on one computer and/or distributed between two or more computers or processors.

The word “exemplary” is used herein to mean serving as an example, instance, or illustration. Any aspect or design described herein as “exemplary” is not necessarily to be construed as preferred or advantageous over other aspects or designs.

Some embodiments of the disclosure provide a method for tracking interactive events in a mobile environment. One example method comprises providing a tracking application for tracking interactive events on a first component of a network, and providing a user application capable of performing interactive events of interest on a second component of a network. A list of interactive events that the user application is capable of performing is provided to the tracking application and stored in the first component. The tracking application compares the provided list of interactive events with the list of interactive events of interest to identify which interactive events supported by the application needs to be reported. The corresponding list of interactive events of interest is returned to the user application; and when the user application performs an event of interest, a report is communicated from the user application to the tracking application. The report may be recorded as a metric datum point, for example in the tracking application.

In some embodiments, the interactive events that the user application is capable of performing are correlated with a corresponding action code or event code identifying the interactive event. The action codes or event codes can be stored by the tracking application, and associated with an identifier identifying the user application.

In other embodiments, the list of events of interest can be periodically updated, and the user application is provided with the updated list of events of interest.

In still other embodiments, the step of recording the report as a metric datum point further comprises the step of validating that the action code or event code is a valid action code or event code for the corresponding application.

In some embodiments of the disclosure, the first component is an OMA MobAd Ad Server, and the user application is an OMA MobAd Service Provider Application (Sp App).

In some embodiments of the disclosure, the tracking application can be comprised of a network component and a device component.

In one aspect of this embodiment, the first component is an Open Mobile Alliance Mobile Advertising (OMA MobAd) Enabler comprising an Ad Server in the network and an Ad Engine provided on an electronic device, and the second component is an advertising application (Ad App) on the electronic device.

In another aspect of this embodiment, the Ad Application provides its interactive event capabilities to the MobAd Enabler (for instance at registration), and in return receives a list of interactive events of interest, potentially along with corresponding action codes or event codes. The Ad Application reports interactive events of interest, potentially in the form of a list, as metric identifiers which may map to, correspond to or be associated with the interaction mechanism, action codes or event codes, to the Ad Engine.

In yet another aspect of this embodiment, the first component is a MobAd Enabler comprising an Ad Server and an Ad Engine, and the second component includes or is an agent such as an Ad App, wherein the Ad Server provisions the Ad Engine with interactive events of interest and corresponding action or event codes. In this way, the Ad Engine may refine the list of action or event codes of interest for instance by dropping interactive event codes that cannot be supported due to device capabilities. The Ad Engine receives interactive event data from the Ad App, matches interactive events data to the interactive events of interest, discards the others and reports the events of interest to the Ad Server. The report can be constructed as a list of metric identifiers which may map to, correspond to or be associated with action or event codes and further include associated parameters.

In another aspect of the disclosure, the first component including the tracking application also includes an advertising server with a database of advertising content. In this instance, the user application requests or otherwise receives advertisement from the first component, and the first component matches the advertising content to the interactive capabilities of the user application before returning matching advertising content to the user application.

In another aspect of the disclosure, the interactive capabilities include at least one of a direct message forwarding operation, an indirect forwarding message operation, a bookmarking operation, a direct download operation, an indirect download operation, an operation to invoke an interactive application; and a storing operation.

In some embodiments, a system for tracking advertising in a mobile environment is provided. The system includes a computerized device running a tracking application for tracking interactive events related to advertising and another component running a user application capable of performing interactive events. The tracking application is programmed to query the user application to transmit the list of supported interactive capabilities, to identify events of interest from the list of interactive capabilities, and to receive reports of events of interest for tracking the use of advertisements by the user.

The system can be defined as an Open Mobile Alliance Mobile Advertising (OMA MobAd) environment, wherein the tracking application comprises an Ad Server and an advertising engine (Ad Engine), and the user application includes an advertising application (Ad App). The Ad App can be programmed to use action or event codes to report interactive event data to the Ad Engine, and the Ad Engine can be programmed to identify interactive events of interest from the action or event codes, to discard action or event codes that do not correspond to interactive events of interest, and to report events of interest to the Ad Server.

In some embodiments, an apparatus for tracking interactive events related to advertisements is provided. The apparatus includes a component or components (e.g., processor, etc.) programmed to: monitor interactive events; compare the interactive events to a list of interactive events of interest; and report the event as a metric datum when the interactive event is an event of interest. The step of reporting the event can comprise storing the event in a record of metrics data, or transmitting the event to an external device. The external device can be, for example, an advertising server.

In other embodiments, the apparatus component (e.g., processor) is programmed to include a tracking application and a user application. The user application and the tracking application negotiate interactive events of interest to correlate the capabilities of the apparatus to events of interest prior to use. During operation, the advertising application reports events of interest to the tracking application.

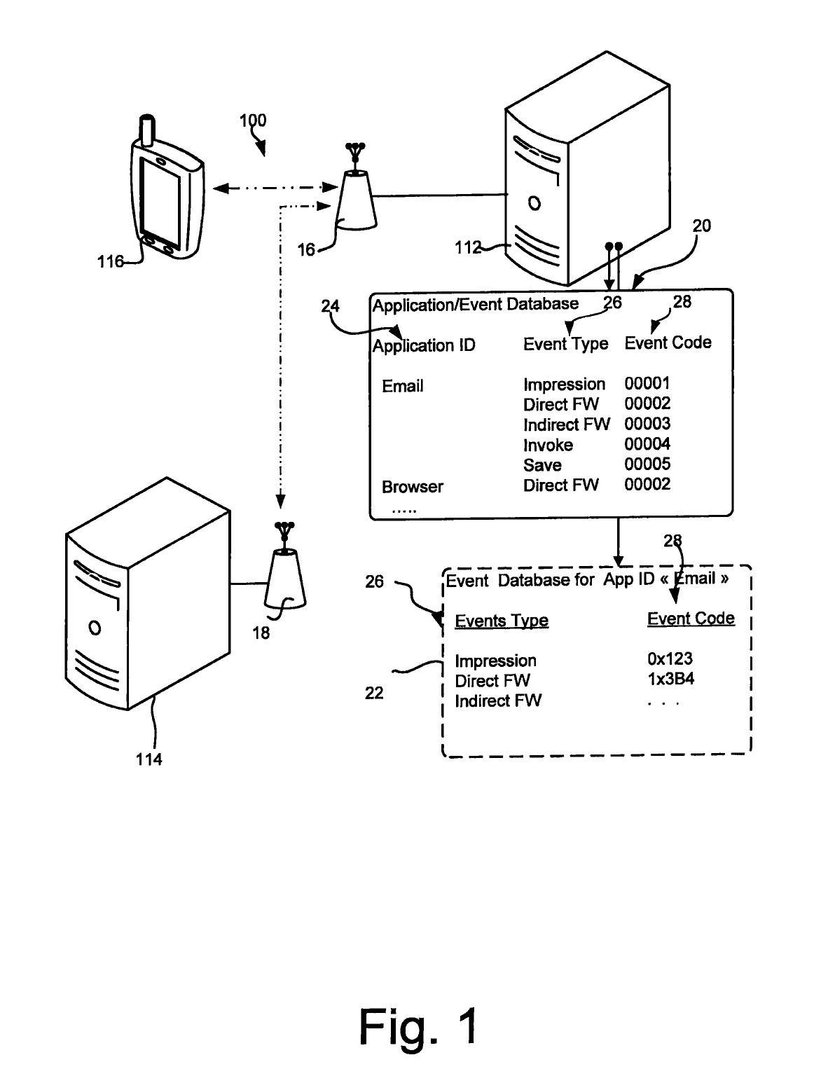

Referring now to the Figures, and more particularly to FIG. 1, an exemplary communication system 100 which can be applied in targeted and viral advertising or marketing methods, is shown. As shown here, the system 100 generally includes an advertising server 112′, a service provider computer 114, and a personal communications device or electronic device 116. As shown, components of the system 100 communicate with each other through one or more of a wired network and a wireless network (e.g., established and maintained by access points 16 and 18 as shown), although various types of wired and wireless communications networks can be used, as will be apparent to those of ordinary skill in the art. While an exemplary system is shown in FIG. 1, it will be apparent that system components may be configured otherwise, for example including any number of components or various relational interconnections (e.g., ad-hoc, peer to peer, etc.). Although, as shown here, the electronic device 116 can be a wireless device such as a mobile telephone, a personal digital assistant, handheld or lap top computers, or similar devices that have telecommunications capabilities, in some embodiments electronic device 116 may also be a desktop computer, a set top box or a network node.

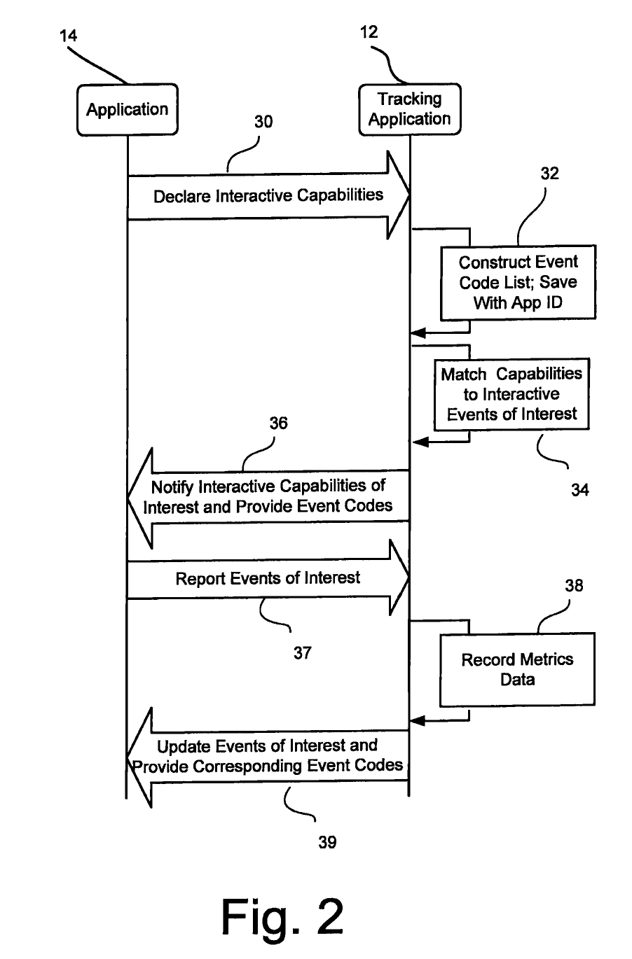

Referring again to FIG. 1 and also to FIG. 2, a tracking application 12 for tracking interactive events related to advertisements is provided on the system 100 along with a user application 14 that produces, facilitates or otherwise enables interactive events relative to advertising content. The advertisements may be displayed or otherwise provided on electronic device 116 by an ad application thereon. In the following example, the tracking application is provided on server 112, and the application 14 that performs the interactive events is provided on device 116. As described more fully below, however, the tracking application 12 can be provided on the server 112, in electronic device 116, or as a combination of components in the server 112 and electronic device 116. The user application 14 can be: a service provider application, which is provided by, configured on, or otherwise functionally-enabled by the service provider computer (e.g., an application server); or an ad application on the electronic device 116.

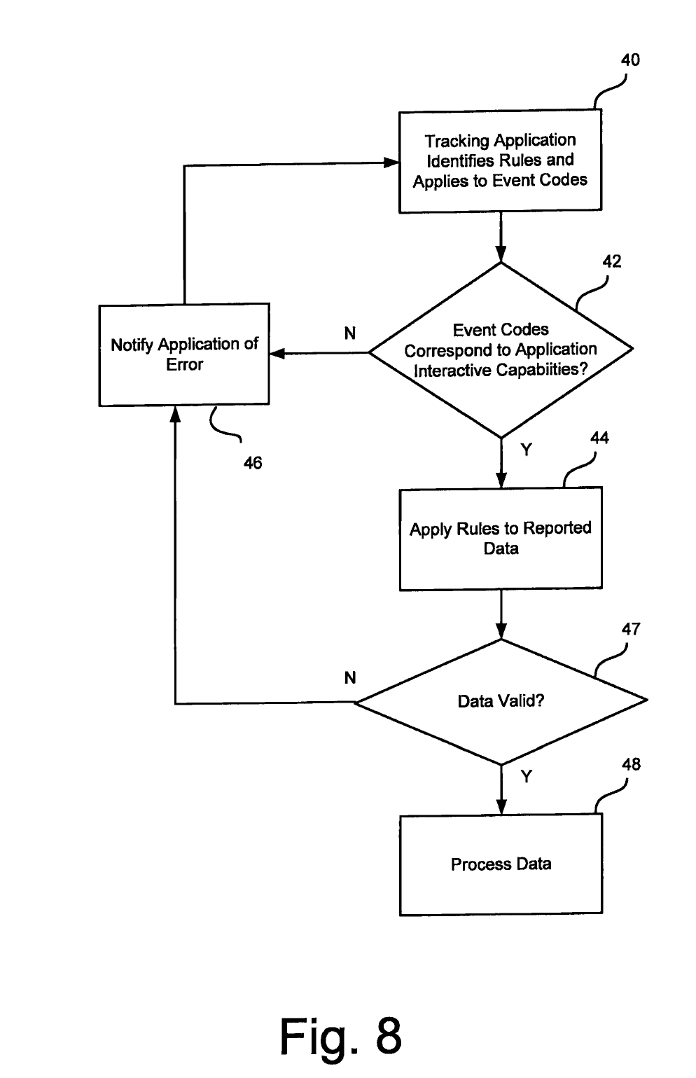

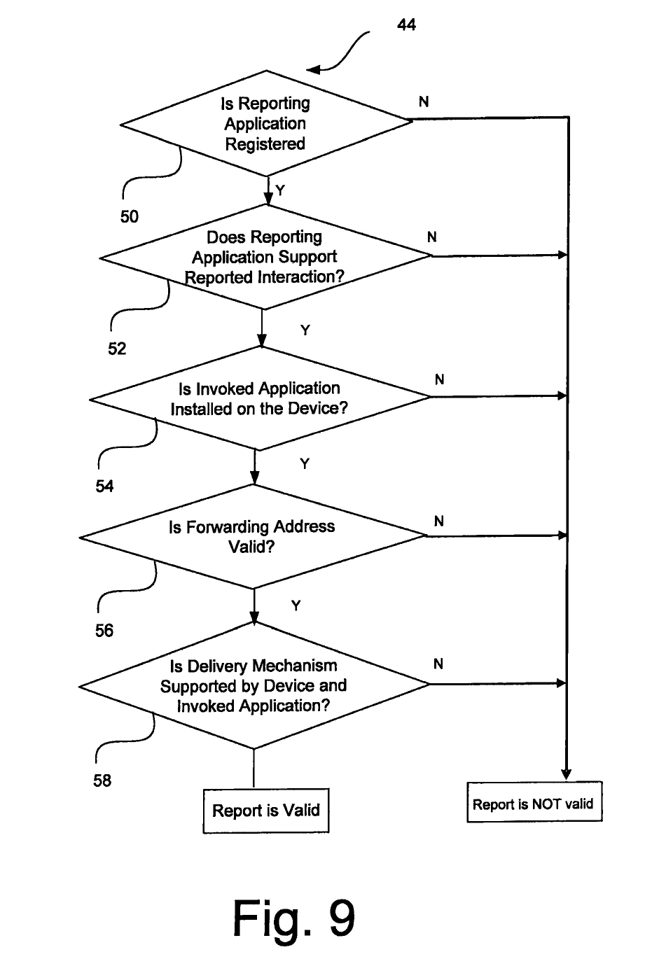

Referring still to FIGS. 1 and 2, to track these interactive events, the tracking application 12 may store predefined action codes or event codes identifying interactive event types, and may include a database 20 that correlates an application identifier 24 for each application 14 registered with the system 100 with a list of “interactive event types” 26 for tracking activity related to advertising, and the “action code” or “event code” 28 that has been associated with each interactive event type or interaction/interactive mechanism. The action or event codes can be defined as generic codes that are stored in memory in the tracking application 12, and may be used for all applications as shown in database 20. Alternatively, the event codes can be generated based on application name or identifier and the event types it supports as shown in the exemplary database 22. In the second case, referring to database 22, the tracking application 12 can receive action or event codes without an application identifier as the application identifier can be deduced from the action or event code. Furthermore, when both action or event codes and application identifier are transmitted, the tracking application 12 can validate the authenticity of metric data by comparing the code to the application identifier, as described below with reference to FIGS. 8 and 9. In still another alternative, no action or event codes are assigned, and the interactive capabilities can be expressed in raw data, in XML format or any other data format.

Interactive capabilities that are of interest to the tracking application 12 can include, for example, direct or indirect message forwarding, bookmarking, direct or indirect downloading, invoking another application (e.g., a browser application, a phone application, an email application, an instant messaging (IM) application, etc.) to initiate an interaction, and storing of content. Direct or indirect message forwarding or downloading, for example, can be provided on the electronic device 116 if the electronic device has email or download capabilities. Indirect messaging or downloading can be provided in the advertising content, for example, by a service provider on server 114 which embeds a link (e.g., URL or URI) to email or download in the advertising content if the action or event code associated with the content specifies a corresponding action/event such as indirect messaging or downloading. Both types of actions are of interest in tracking advertisements for targeted and viral advertising, and can be tracked in the disclosed system. As used herein, the term “interactive event” refers to initiation or completion (e.g., relative to a user activation) of an interactive capability of the type described above, such as forwarding a message, bookmarking content, or activating a download function.

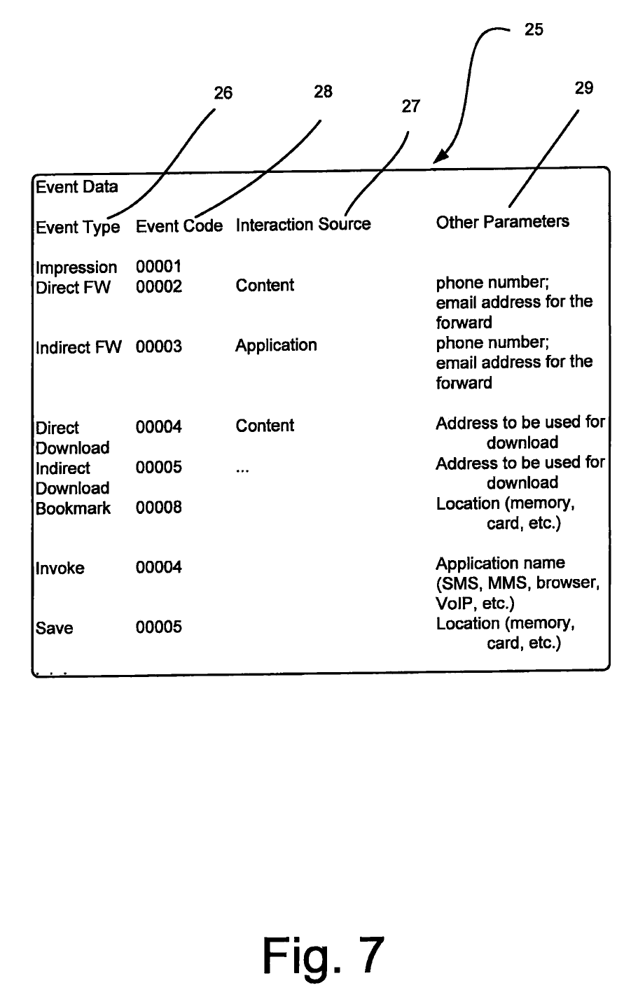

The tracking application 12 can also store additional information along with even types in database 25, as shown in FIG. 7. In addition to events and event codes, the database 25 can also include a source identifier 27 for an event, and other parameters 29 related to the event, where the source identifier 27 defines which source is providing the interactive capabilities. The other parameters 29 can include, for example, phone numbers, email addresses, the names of invoked applications, and other data that can be provided along with a reported user interaction that may be employed for analysis of tracking events.

The user application 14 can store events of interest 26 to the tracking application 12 and associated action or event codes 28, as described above with reference to databases 20 and 22.

Although databases 20, 22, and 25 are illustrated in table format in order to simplify this explanation, it should be understood that the databases 20, 22 and 25 are repositories for data which may take any form known in the art (e.g., relational database, lookup table, etc.) and, in many cases, may be different (e.g., more complex) than the table database illustrated.

Referring now to FIG. 2, a flow chart illustrating a method for populating the databases 20 or 22 of FIG. 1 is shown. When the user application 14 registers with the system 100, the user application 14 transmits a message to the tracking application 12 providing an application identifier 24 and a list of interactive capabilities at step 30, as shown in the following exemplary XML code:

```
  <supported_events>
  xmlns=“http://www.rim.com”
xmlns:xsi=“http://www.w3.org/2001/XMLSchema-instance”
xsi:schemaLocation=“http://www.com.com interactive_events.xsd”>
  <application_id>Mobile Mall</application_id>
  <event_type>Impression</event_type>
  <event_type>Direct Forward</event_type>
  <event_type>Indirect Forward</event_type>
  <event_type>Direct Download</event_type>
  <event_type>Indirect Download</event_type>
  <event_type>Direct Contact</event_type>
  <event_type>Indirect Contact</event_type>
  <event_type>Store</event_type>
  </supported_events>
```

Here, the application identifier 24 is “Mobile Mall” and the activity or event types 28 include impression, direct forward, indirect forward, direct download, indirect download, direct contact, indirect contact, and store, as shown.

Upon receipt of this data, in step 32, the tracking application 12 constructs a list of interactive capabilities and activity or event codes 28 that correspond to the interactive capabilities and saves the interactive capabilities and activity/event codes 28 with the application identifier 24. The tracking application 12 in step 34 compares the list of interactive capabilities to a listing of interactive capabilities of interest, and, in step 36, transmits the events of interest 26 and corresponding activity/event codes 28 to the user application 14, as shown in the following exemplary XML code:

```
  <events_of_interest>
xmlns=“http://www.rim.com”
xmlns:xsi=“http://www.w3.org/2001/XMLSchema-instance”
xsi:schemaLocation=“http://www.com.com interactive_events.xsd”>
<tracking_system_id>Addtracker001</tracking_system_id>
- <event_mapping>
  <event_type>Impression</event_type>
  <event_code>0001</event_code>
  </event_mapping>
- <event_mapping>
  <event_type>Direct Forward</event_type>
  <event_code>0002</event_code>
  </event_mapping>
- <event_mapping>
  <event_type>Indirect Forward</event_type>
  <event_code>0003</event_code>
  </event_mapping>
- <event_mapping>
  <event_type>Direct Download</event_type>
  <event_code>0004</event_code>
  </event_mapping>
- <event_mapping>
  <event_type>Indirect Download</event_type>
  <event_code>0005</event_code>
  </event_mapping>
  </events_of_interest>.
```

Here, the events of interest are impression, direct forward, indirect forward, direct download, and indirect download, and these event types are mapped to activity/event codes (e.g., 0001 through 0005 as indicated above). Although the application 14 is capable of providing direct contact, indirect contact, and store functions, these are not tracked in this example and, therefore, these event types are not mapped to activity/event codes.

As the user application 14 is used, it reports events of interest in the form of identifiers, which correspond to at least one of interactive/interaction mechanisms and activity/event codes 28, to the tracking application 12 at step 37, as shown in the following exemplary XML code:

```
<event_report>
    xmlns=“http://www.rim.com”
  xmlns:xsi=“http://www.w3.org/2001/XMLSchema-instance”
  xsi:schemaLocation=“http://www.com.com interactive_events.xsd”>
    <application_id>Mobile Mall</application_id>
    <content id = “A123” />
    <event_code>0002</event_code>
    <interaction_source >Application</interaction_source>
    <invoked_application> BB Messenger </ invoked_application>
    <forward_address>friend@rim.com</forward_address>
  </event_report>
```

As shown here, the interaction source identifies whether the interactive mechanism is provided by the content (e.g. as a hyperlink) or by the application processing the content (e.g. by invoking another application). The content could also be specified by its URI:
<content uri=“http://www.contentprovider.com/content.html”/>

The tracking application 12 records metric data associated with activity/event code 28 corresponding to the event of interest at step 38, in a database such as the database 25 shown in FIG. 7. When events of interest change, the tracking application 12 transmits new or modified list of events and corresponding activity/event codes, or the decision to delete events of interest and corresponding activity/event codes 28 to the user application 14 at step 39.

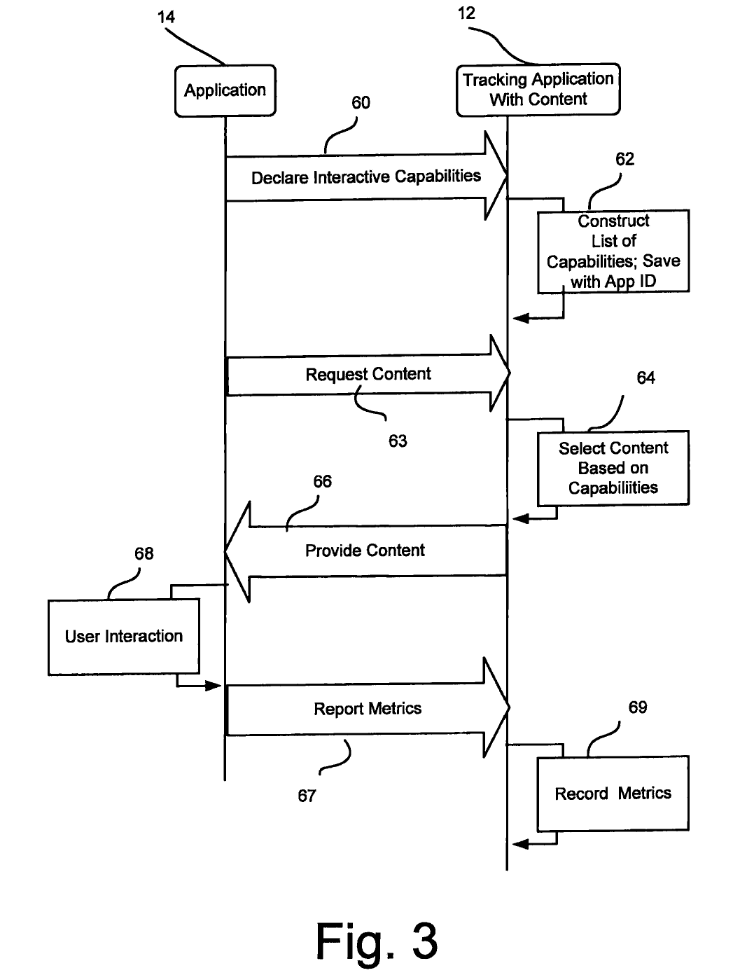

Referring now to FIG. 3, in some instances, the tracking application 12 can be combined with a content provider. The content provider can be, for example, a source providing the content (e.g. an advertiser). In an Open Mobile Alliance Mobile Advertising (OMA MobAd) environment, discussed more fully below, the content provider can also be a content delivery provider, such as an Ad network, a content façade, such as an OMA Broadcast Services Enabler Suite (BCAST) or an OMA Dynamic Content Delivery (DCD) Enabler. In this way the content provider may provide more relevant or targeted content. In step 60, when an application 14 registers with the tracking application, the application 14 will declare interactive capabilities, as discussed above with reference to FIG. 2. The tracking application 12, at step 62, constructs a database 20 or 22 that correlates event codes 28 for all of the disclosed interactive capabilities with a corresponding application ID. When the application 14 at step 63 requests content via a content request message, the tracking application 12 selects content to be provided based on the interactive capabilities of the application 14 at step 64 and provides this content via a response message to the application at step 66. The content in the response message may include an interactive/interaction/interactivity mechanism such as a reference (e.g., URL or URI) embedded in or otherwise associated with the content.

The selection of content can, in some instances, be made by matching the content to interactive capabilities. That is, a set of content provided to the application could be selected from a set of alternative versions of the content or specific transformations applied by the content provider to match the content to application capabilities. For example, if email is not supported replace email links with URLs to the content provider servers. Interactive mechanisms, for example, a “click to” link such as “click to bookmark” or “click to call” link can be embedded in or associated with the content, Interactive mechanism can be removed from the content or otherwise changed or adapted (e.g., by a transformation) before sending the content to the application, thereby matching the content to the capabilities of the user application 14. After user interaction (e.g., viewing, listening or otherwise consuming advertisements) with the application 14 at step 68, metrics are reported at step 67 via a report message from the application 14 to the tracking application 12 which stores in step 69 the metrics in a database which may be of the type illustrated in FIG. 7.

Referring again to FIG. 1, in one embodiment, the advertising system 100 is defined, established or otherwise provided according to or in an Open Mobile Alliance (OMA) Mobile Advertising (MobAd) environment. Here, server 112 is an Ad Server, and service provider computer 114 may execute an application server or otherwise enable functionality of a Service Provider Application (Sp App), as defined by OMA. The Sp App, which may be executing on the service provider computer 114, registers with the system 100 and provides a list of interactive capabilities to the Ad Server 112, which provides corresponding event codes 28, as described above with reference to the steps of FIG. 2.

In the OMA MobAd environment, the electronic device 116 can provide the tracking function 12, either alone or in combination with a component on the Ad Server 112, and can also provide the user application 14, as described below.

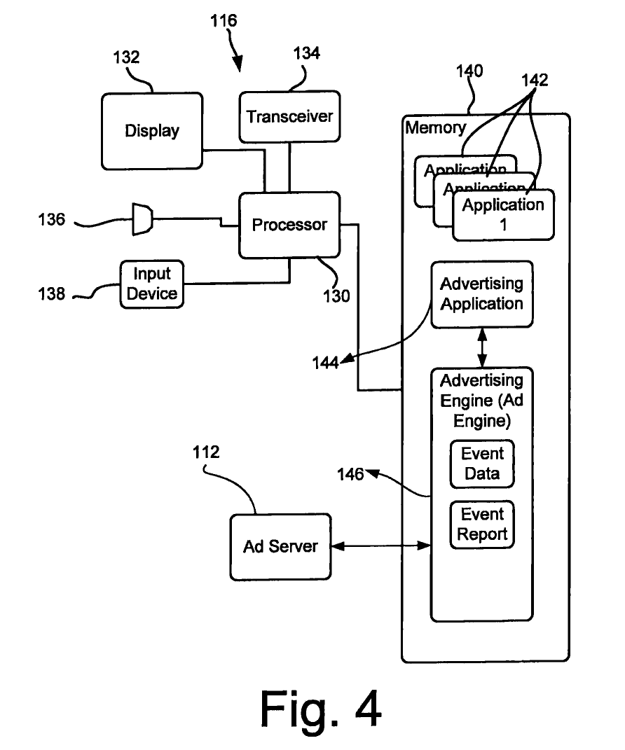

Referring now to FIG. 4, a block diagram of an exemplary electronic device 116 for use in OMA MobAd environment is illustrated. Exemplary electronic device 116 includes a processor 130 linked to a memory 140, a transceiver 134, a user input device 138, an electronic display device 132, and an audio component 136 (e.g., a speaker).

Communications between the electronic device 116 and other components of the system 100 are provided through the transceiver 134. Communications between the user and processor 130 are provided through display 132, audio component 136, and user input device 138.

Processor 130 runs application programs 142 (hereinafter referred to interchangeably as applications, programs, or application programs) stored in memory 140. Here, these programs include an advertising engine (Ad Engine) 146, and an advertising application (Ad App) 144, which in some instances may be an application such as a browser application or game application that is functionally enabled by a service provider computer (e.g., server). The Ad App 144 provides advertisements to the user of the electronic device 116 on user interface devices including electronic display 132, audio component 136, and the like. The Ad Engine 146 is in communication with both the Ad App 144 resident on electronic device 116, and with Ad Server 112, and can provide the tracking function, or cooperate with the Ad Server 112 to provide the tracking function, as described below. The Ad Engine 146 obtains appropriate ads from the Ad Server 112 or elsewhere in the system 100, such as from local storage in the electronic device 116. The Ad Engine 146 receives event data from the Ad App 144, and can report metric data to the Ad Server 112 as described below. The Ad Engine 146 can also provide other functions, such as comparing event codes 28 provided by the Ad Server 112 to capabilities associated with the electronic device 116, filtering of event codes 28 to identify supported events of interest 26 to the Ad Server 112.

Referring again to FIG. 2, in one exemplary embodiment, the Ad Engine 146 provides the tracking function. Here, Ad App 144 registers with the Ad Engine 146 in electronic device 116, which provides the action/event codes 28 and tracks metrics, as described above, and stores the events of interest 26 and associated action/event codes 28.

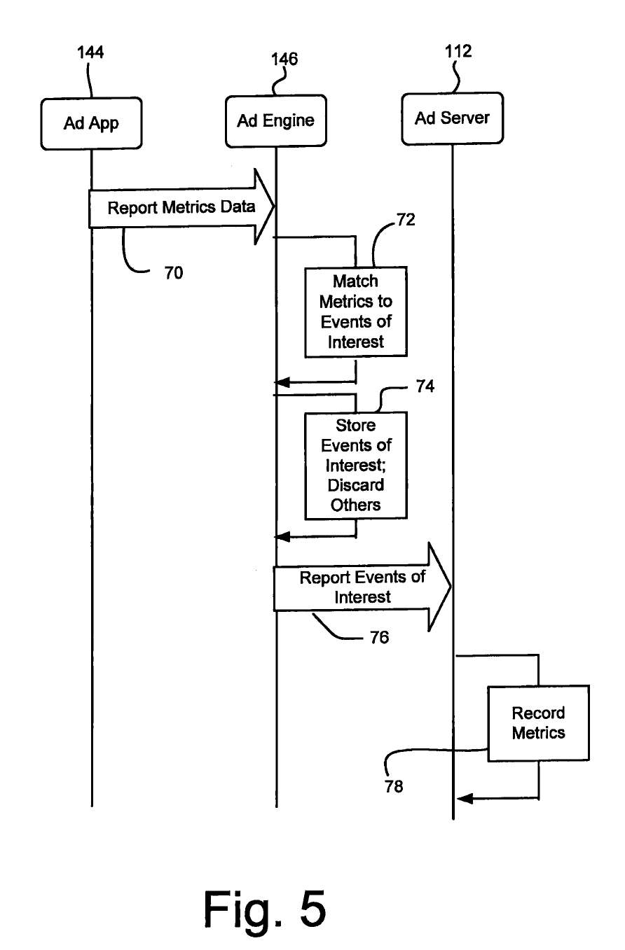

In other embodiments, the tracking application 12 can be provided by a combination of a network component operating on Ad Server 112 and a device component (e.g., Ad Engine 146) on electronic device 116 which together provide a MobAd Enabler. Referring now to FIG. 5, rather than providing a list of interactive capabilities to the Ad Engine 146 as described above, the Ad App 144 may instead be configured to report metrics data to Ad Engine 146 in the electronic device 116 at step 70. The Ad Engine 146 matches the received data to interactive events of interest at step 72, and saves events of interest at step 74. The events of interest are reported to the Ad Server 112 at step 76, which records the events 26 at step 78.

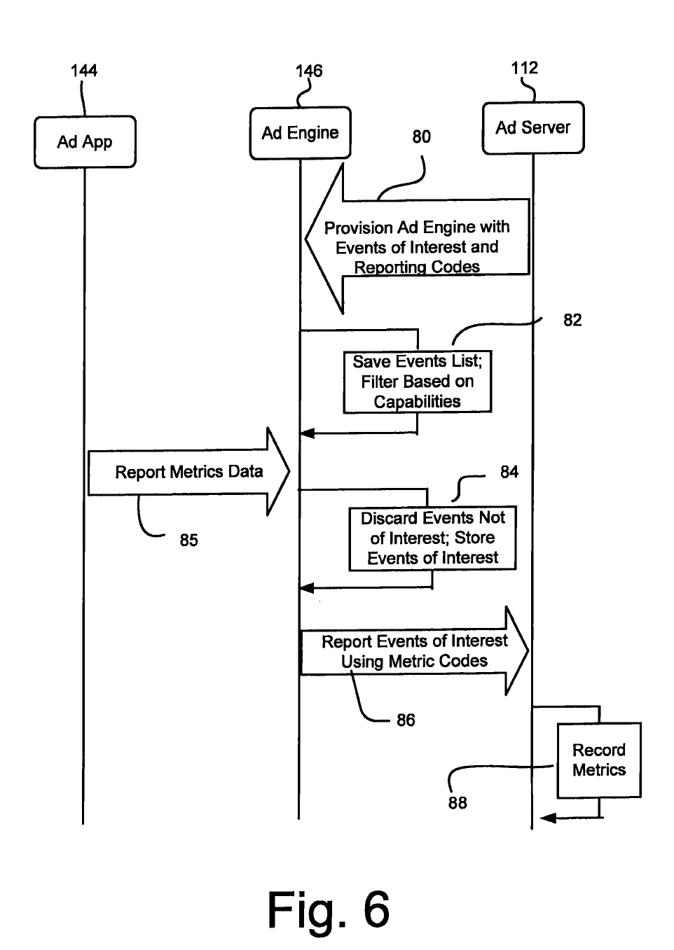

Referring now to FIG. 6, in another alternative embodiment, the Ad Server 112 provisions the Ad Engine 146 with interactive events of interest 26 and associated event codes 28 at step 80. At step 82, the Ad Engine 146 can store all of the events of interest 26 and associated codes 28, or filter the list based on the known capabilities of the electronic device 116, and store only those events that the electronic device 116 is capable of providing (step 82). During operation, the Ad App 144 provides metrics data related to a user interaction to the Ad Engine 146 at step 85. The Ad Engine 146 can compare the metrics data provided by the Ad App 144 to the events of interest 26 for the tracking application 12, store the events of interest at step 84, and discard all other events. At step 86, the Ad Engine 146 either continually or periodically provides reports of events of interest using the event codes to the Ad Server 112, which stores or records the metrics data at step 88. Although the Ad Engine 146 can filter the events of interest as described above, as an alternative, the Ad Engine 146 and Ad App 144 can negotiate the interactive events of interest prior to step 80 or 85 above. Here, the Ad App 144 reports only the events of interest to the Ad Engine 146, and the Ad Engine 146 reports these events to the Ad Server 112.

Referring now to FIGS. 8 and 9, flow charts illustrating methods for validating the interactive event data are shown. When the content includes active content, such as ActiveX, EcmaScript, or Adobe Flash routines that may simulate user actions on the tracked content, it is desirable to analyze the metrics provided to limit or prevent false actions from being tracked. To provide this verification, the tracking application 12 can include rules and policies for analyzing the metrics before the metrics are reported.

Referring now to FIG. 8, to provide this verification, at step 40 the tracking application 12 identifies rules applying to an event code for the identified application. These rules may be provided, for example, by a service provider. After the rules are identified, in step 42, the tracking application 12 verifies: 1) that the events recorded in the metric data correspond to the interactive capabilities declared by the application; 2) that the event codes from the metrics data match the event codes associated with the corresponding application identifier in database 20 or 22; and 3) that the data associated with an event code is within any limits associated with that code. If an error is found, the error is reported to the user application 14 at step 46.

If no error is found, and the codes are valid, the tracking application 12 can provide further verification by applying a series of rules and policies on the reported data (step 44). These rules, again, can be specified by a service provider associated with the identified user application 14. Referring now to FIG. 9, an exemplary series of rules is shown. Initially, in step 50, the tracking application 12 verifies that the user application 14 is registered with the network 100. This verification can be made, for example, based on the <application_id> tag, as shown in the XML code described above with reference to FIG. 3. In step 52, the tracking application 12 verifies that the user application 14 supports the reported interaction. This verification can be made based on the <application_id> and <event_code> tags.

Optionally, if the user application 14 has registered with the network 100 and provided data regarding applications available to be invoked and delivery mechanisms associated with the device, or if the tracking application 12 is resident on the electronic device 116, as described previously, the following steps are additionally performed. In step 54, the tracking application 12 verifies that the invoked application is available to user application 14, based on an <invoked_application> tag. The tracking application 12 then verifies that any forwarding address is valid, or is at least in a valid format at step 56. This verification can be made, for example, based on a <forward_address> tag. Finally, the tracking application 12 verifies that the device executing the application includes an appropriate delivery mechanism to execute the invoked application at step 58. This verification can be made by reference to the <invoked_application> and <forward_address> tags.

If the answer to any of the queries provided in steps 50-58 is no, the report is invalid, and the application 14 is notified. If the answer to all of the queries is yes, then the report is valid. Referring again to FIG. 8, if all of the data are validated (step 47), the data is processed (step 48) and forwarded to the application 14.

The particular embodiments disclosed above are illustrative only, as the disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the disclosure.

For example, although specific components are described above as associated with the tracking application 12 and application 14, it will be apparent in a network environment that these functions can be provided in any location on the network. Furthermore, although a specific mobile environment is described, it will be apparent that the disclosure can be applied in many different network environments. Additionally, although event codes are discussed above, it will be apparent that the interactive capabilities and interactive events can be determined directly from XML code, and that the event codes are not required in all applications. Thus, the disclosure is to cover all modifications, equivalents, and alternatives falling within the spirit and scope of the disclosure as defined by the following appended claims.

What is claimed is:

1. A method for interactive advertising, the method comprising:
communicating, to an application on an electronic device, a message including advertising content and at least one of an interactive mechanism and an action code; and
receiving, from the application, a metric report including an identifier, the identifier indicating that an event corresponding to the interactive mechanism has occurred relative to the advertising content.

2. The method of claim 1 wherein the identifier corresponds to the action code.

3. The method of claim 1 wherein the metric report further includes a parameter specifying one of: impression information, a URL, a phone number, an email address, and a name of an invoked application.

4. The method of claim 1 wherein the action code is associated with the interactive mechanism.

5. The method of claim 1 wherein the application is compliant with the Open Mobile Alliance (OMA) Mobile Advertising (MobAd) specification.

6. The method of claim 5 wherein the communicating is performed by an Ad Server, and the application an Ad Engine.

7. The method of claim 1 wherein the interactive mechanism is one of a direct message forwarding operation; an indirect forwarding message operation; a bookmarking operation; a direct download operation an indirect download operation; an operation to invoke an interactive application; and a storing operation.

8. The method of claim 1 wherein the interactive mechanism is a URI associated with the advertising content.

9. A method for interactive advertising, the method comprising:
receiving, at an application on an electronic device, a message from an advertising server, the message including advertising content and at least one of an interactive mechanism and an action code; and
communicating, from the application to the advertising server, a metric report including an identifier indicating that an event corresponding to the interactive mechanism has occurred relative to the ad content.

10. The method of claim 9 wherein the identifier corresponds to the action code.

11. The method of claim 9 wherein the metric report further includes a parameter specifying one of: impression, a URL, a phone number, an email address, and a name of an invoked application.

12. The method of claim 9 wherein the action code is associated with the interactive mechanism.

13. The method of claim 9 wherein the application and the advertising server are compliant with the Open Mobile Alliance (OMA) Mobile Advertising (MobAd) specification.

14. The method of claim 13 wherein the application is an OMA MobAd Ad Engine.

15. The method of claim 13 wherein the application is an OMA MobAd Ad application (Ad App).

16. The method of claim 9 wherein the interactive mechanism is one of a direct message forwarding operation; an indirect forwarding message operation; a bookmarking operation; a direct download operation an indirect download operation; an operation to invoke an interactive application; and a storing operation.

17. The method of claim 9 wherein the interactive mechanism is a URI associated with the advertising content.

18. A method for interactive advertising, the method comprising:
receiving a communication at an application on an electronic device, the communication being from an ad engine on the electronic device and including advertising content and at least one of an interactive mechanism and an action code associated with the ad content;
displaying an advertisement based on the advertising content;
receiving an input invoking the interaction mechanism associated with the advertising content; and
providing, to the ad engine, a metric report containing an identifier indicating that an event corresponding to the interactive mechanism has occurred relative to the advertising content.

19. The method of claim 18 wherein the identifier corresponds to the action code.

20. The method of claim 18 wherein the metric report further includes a parameter specifying one of: impression, a URL, a phone number, an email address, and a name of an invoked application.

21. The method of claim 18 wherein the action code is associated with the interactive mechanism.

22. The method of claim 18 wherein the ad engine is compliant with the Open Mobile Alliance (OMA) Mobile Advertising (MobAd) specification.

23. The method of claim 22 wherein the method is performed by an OMA MobAd Ad App on the electronic device.

24. The method of claim 18 wherein the interactive mechanism is one of a direct message forwarding operation; an indirect forwarding message operation; a bookmarking operation; a direct download operation an indirect download operation;
an operation to invoke an interactive application; and a storing operation.

25. The method of claim 18 wherein the interactive mechanism is a URI associated with the advertising content.

26. A method for interactive advertising, the method comprising:
receiving at an application server, a message from an Ad Server, the message including advertising content and at least one of an interactive mechanism and an action code; and
sending, from the application server, a metric report to the Ad Server, the metric report including an identifier indicating that an event corresponding to the interactive mechanism has occurred relative to the advertising content.

27. The method of claim 26 wherein the identifier corresponds to the action code.

28. The method of claim 26 wherein the metric report further includes a parameter specifying one of: impression information, a URL, a phone number, an email address, and a name of an invoked application.

29. The method of claim 26 wherein the action code is associated with the interactive mechanism.

30. The method of claim 26 wherein the application server and the Ad Server are compliant with the Open Mobile Alliance (OMA) Mobile Advertising (MobAd) specification, the application server being a Service Provider Application (SP App).

31. The method of claim 26 wherein the interactive mechanism is one of a direct message forwarding operation; an indirect forwarding message operation; a bookmarking operation; a direct download operation an indirect download operation; an operation to invoke an interactive application; and a storing operation.

32. The method of claim 26 wherein the interactive mechanism is a URI associated with the advertising content.
